(19) United States
(12) Patent Application Publication
(10) Pub. No.: US 2015/0106286 A1
(43) Pub. Date: Apr. 16, 2015

(54) Performance, Productivity And Efficiency Planning For Employee Relocation Program Effectiveness

(71) Applicant: Randall T. Decker, Hillsborough, NJ (US)

(72) Inventor: Randall T. Decker, Hillsborough, NJ (US)

(21) Appl. No.: 14/052,350

(22) Filed: Oct. 11, 2013

(51) Int. Cl. G06Q 10/10

(52) U.S. Cl. CPC G06Q 10/105
USPC 705/320

(57) ABSTRACT

A method of employee relocation program planning designed to maximize program effectiveness through the assessment of benefit performance, benefit efficiency, and employee productivity to internal and external groups, and the defining of principles and methodologies. Employee surveys capture satisfaction responses for counseling, services, and benefit effectiveness, and employee perception of benefit importance and program expectations. Survey results are calculated to produce performance, productivity and efficiency scores; whereto program-balancing principles and methodologies are applied to increase program effectiveness. Computerized applications collect, store and calculate data, and includes tools programmed to dynamically model performance balancing scenarios for achieving desired outcomes. Additional functionality applies productivity outputs against comparable variables for analyses of alternate company programs, including talent mobility planning, return on investment and cost management.

### BACKGROUND FOR THE INVENTION

Most government entities and medium to enterprise size companies relocate employees from one geographical location to another. The goal for these relocations is generally to attract new and existing talent to areas where no other viable employee candidates exist. The types of benefits offered under these relocation plans can be extensive, ranging from the transportation of household goods to the sale and purchase of new homes. Average costs for a full-program move can easily exceed one hundred thousand dollars per employee. The aggregate of these costs can be staggering depending on the number of moves that a company performs. Medium size companies may move a few employees, while large and enterprise companies often average 250 to 2,000 moves annually. Some government agencies and mega corporations conduct more than 5,000 relocations per year.

To the extent that relocation benefits have expanded over the years, a clear process for managing overall program effectiveness has been difficult to establish. Even though benefit offerings are for the most part standardized, there is little consensus over what makes a relocation program effective. Individual entities and external suppliers routinely analyze programs through surveys to track the satisfaction of employees, whereby decisions are made to adjust benefits and services when possible. But the lack of industry-wide standard measures or a proven methodology for determining program effectiveness impedes industry efforts to make meaningful and sustainable change. Even as satisfaction rises to achieve a desired percentage, it is an ill-conceived notion that higher employee satisfaction relates to a better program. Good company stewardship dictates a rationalized balance of needs between employee and company, among additional determining factors.

A more complete way to assess relocation effectiveness is to expand the scope of data collection in a way that enables comprehensive, dimensional views into all workings of the program, and then applying advanced principles and methodologies for in-depth analyses. To achieve greater comprehension, satisfaction sub-indicator measures should be collected and assessed for counseling competence, service performance and benefit provisions, as well as benefit importance and employee expectation data. In aggregate, these enhanced measures supply the means for calculating and applying advanced methodologies for balancing the performance, productivity and effectiveness results needed to drive sustainable and meaningful relocation program change.

### SUMMARY OF THE INVENTION

The performance, productivity and efficiency planning invention for employee relocation programs is a methodology that determines relocation program effectiveness through the surveying, analysis and application of defined principles, which is subsequently supported by a computerized management tool.

In accordance with this invention, a systematic approach to surveying recently relocated employees on specific satisfaction measures is applied to assess overall satisfaction, comprising counseling competence, service performance and benefit provisions. In addition, the survey collects employee perception of benefit importance, employee expectations and other pertinent information.

In accordance with this invention, a series of statistical applications are applied to satisfaction results to determine performance, productivity and efficiency scores. The results are presented in multiple ways and views that highlight program effectiveness for consumption by clients or other interested parties.

In accordance with this invention, balancing principles are applied to the scored results mentioned herein, directing deliberate actions to be performed by relocation program administrators to increase program effectiveness. Specifically, an actionable directive is derived to move performance scores upward or downward to achieve a 100 percent score along the performance curve for each benefit. Specifically, an actionable directive is derived to increase or decrease productivity scores in accordance with defined comparative groups, such as industry peers, to rise or lower the 100 percent performance score along the performance curve. Specifically, an actionable directive is derived to increase or decrease efficiency scores of under performing or over performing benefits within the overall boundaries of performance and productivity scoring.

In accordance with this invention, computerized tools are applied to collect and calculate results for presentation of actionable directives. Specifically, worldwide web enabled data collection systems gather satisfaction and supporting data. Specifically, databases consolidate web and locally entered data to score and calculate results. Specifically, a computerized tool comprises all actionable results in dynamic fashion, permitting infinitely variable scenario modeling of program performance, productivity, effectiveness, and satisfaction options.

In accordance with this invention, productivity score results are calculated in specific and proprietary fashion for application in the overall program noted herein and, in addition, for use in external modeling of general corporate analyses who's formulae are not included in this invention, such as return on investment, talent mobility planning and cost management.

### BRIEF DESCRIPTION OF THE DRAWINGS

The accompanying drawings illustrate various embodiments of the principles described herein and are part of the invention specification. These drawings are merely examples and do not limit the scope of the claims.

FIG. 1 is a block diagram illustrating the macro process of the relocation program planning system and includes reference to other invention figure numbers herein.

FIG. 2 is a flow chart illustrating one method of data collection processes according to one of the embodiments of the principles described herein.

FIG. 3 is a flow chart illustrating some of the category components of collected data according to one of the embodiments of the principles described herein.

FIG. 4 is a flow chart illustrating some of the final outcomes of derived data applications according to one of the embodiments of the principles described herein.

FIG. 5 is a diagram illustrating some of the basic process flows for strategic balancing techniques according to one of the embodiments of the principles described herein.

FIG. 6 is a chart illustrating some of the performance balancing techniques according to one of the embodiments of the principles described herein.

FIG. 7 is a chart illustrating some of the productivity balancing techniques according to one of the embodiments of the principles described herein.

FIG. 8 is a chart illustrating some of the efficiency balancing techniques according to one of the embodiments of the principles described herein.

FIG. 9 is a worksheet picture illustrating one version of a relocation program-modeling tool according to one of the embodiments of the principles described herein.

FIG. 10 is a screen view picture illustrating one version of a relocation program-modeling tool according to one of the embodiments of the principles described herein.

FIG. 11 is a visualization illustrating one of the techniques for utilizing productivity data results according to one of the embodiments of the principles described herein.

### DETAILED INVENTION DESCRIPTION

The most effective employee relocation programs deploy a set of well performing benefits that meet employee expectations, conform to employee need, and provide quality services and support within the realm of overall productivity. Over or under performing programs can negatively impact program effectiveness, cost, and the ability to enable talent mobility.

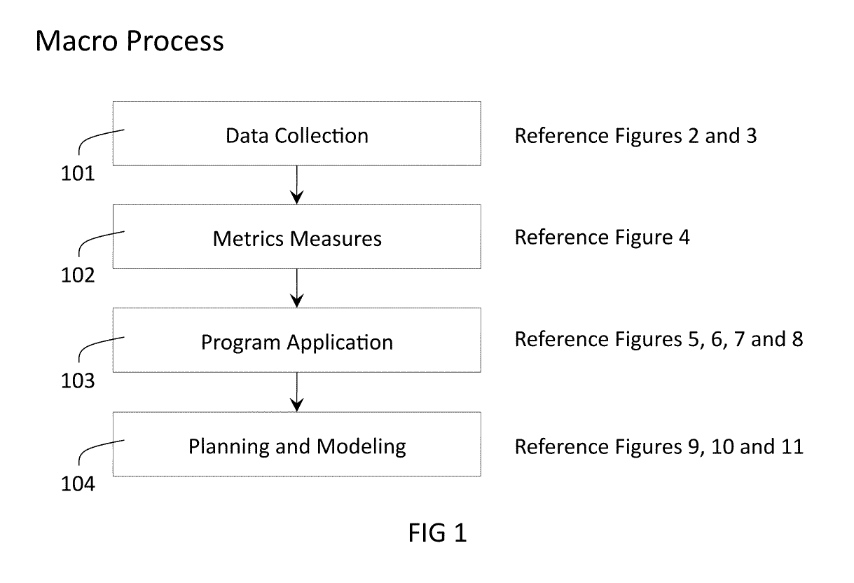

The macro process for this invention (FIG. 1) consists of collecting relocation response data through individual employee surveys (101). The data is processed to supply specific metrics and outcomes (102), enabling the deliberate application of program principles and methodologies for increasing program effectiveness (103). Planning and modeling tools then facilitate the user experience to help make definitive decisions for future relocation program development (104).

Data Collection

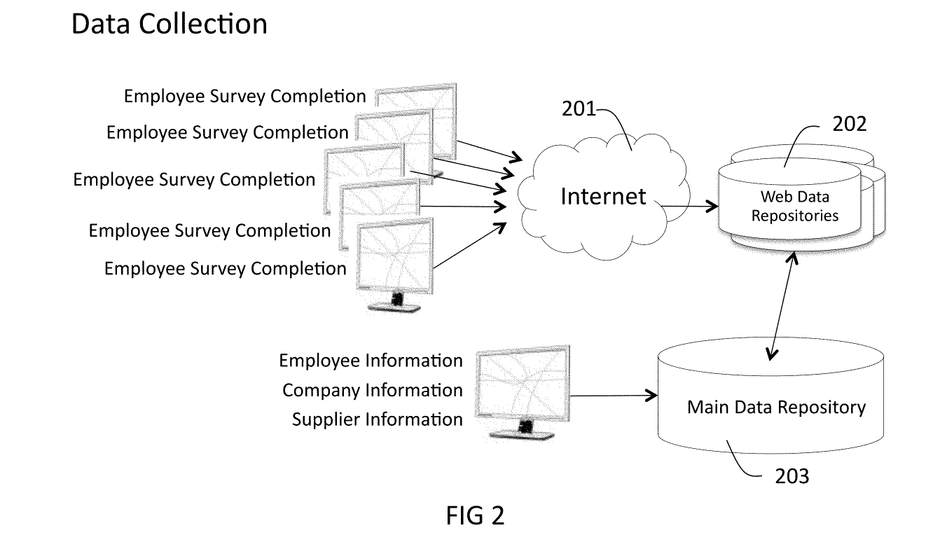

This invention collects data through the worldwide web to survey recently relocated employees using various questioning techniques and scoring options (FIG. 2). Responses are received from employees through a worldwide web interface over the Internet (201) and collected in one or more individual web databases, designated by company (202). This data is further collected in a master database that houses specific client, company, industry and employee information necessary for results processing (203).

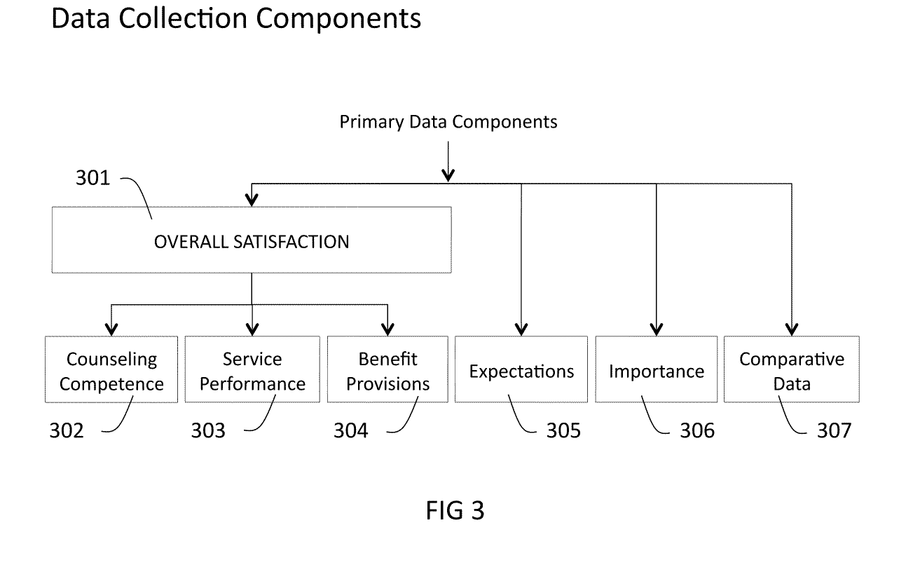

The collection of direct feedback from employees is the foundation on which this invention is based. It is this feedback that drives the formulae to confirm the effectiveness of each relocation program component (FIG. 3).

For the purpose of this invention, satisfaction data is collected and categorized to derive specific outcomes in the calculations phase of the invention. The first set of components measure total satisfaction in three categories, whereto the results of each question are directed (301).

The first category of satisfaction is Counseling Competence (302). All topics relating to counseling or counseling type services are categorized in this manner. Counseling satisfaction provides insight into a much-needed sector of relocation program management to explain the plethora of rules, services, government regulation and processes associated with each move. This data is further calculated and cross-referenced for specific output relating to overall program effectiveness.

The second category of satisfaction is Service Performance (303). All topics relating to physical provisions and processes are categorized in this manner. Service satisfaction generally provides insight into service provider actions, but also applies to processes provided by the client, documentation, and other service type functions. This data is further calculated and cross-referenced for specific output relating to overall program effectiveness.

The third and final category of satisfaction is Benefit Provisions (304). All topics relating to benefit offerings, benefit construct and services offered under the benefit are categorized in this manner. Benefit satisfaction provides insight into the worthiness of what the company has to offer the employee. This data is further calculated and cross-referenced for specific output relating to overall program effectiveness.

In addition to satisfaction, surveys collect data specific to employee Expectations for each company benefit (305). Expectation valuations provide specific cross-reference with satisfaction to later determine performance scores.

In addition to satisfaction and expectation, surveys collect data specific to the Importance of each benefit, as perceived by the employee (306). Importance valuations provide specific cross-reference with satisfaction to later determine efficiency scores.

In addition to satisfaction, expectation and importance scores are the collection of additional comparative data, service supplier and demographic information about or assigned to each employee and company (307). The collection of this data provides further cross-referencing for additional outcomes.

Metric Measures

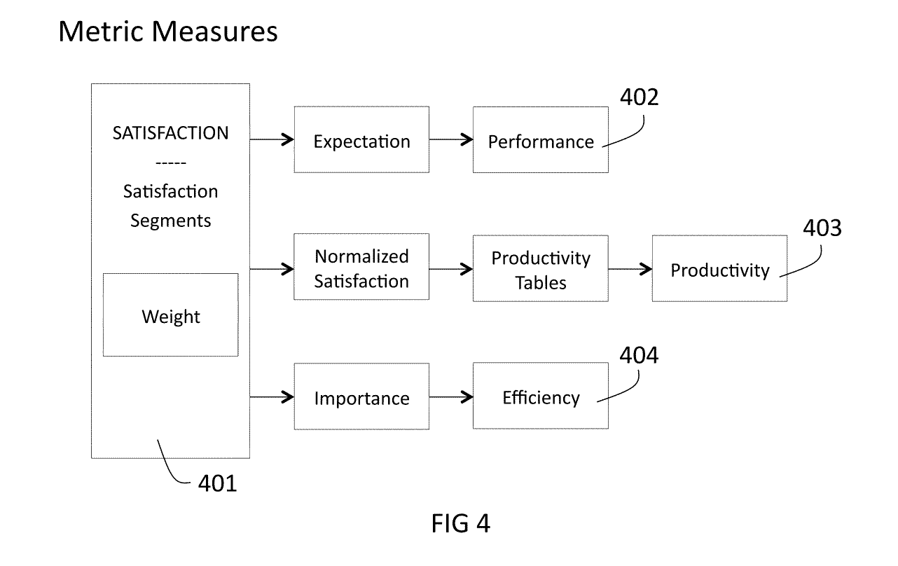

For the purpose of this invention, specific calculations are applied to satisfaction and cross-referencing data to measure defined outcomes for satisfaction, performance, productivity and efficiency (FIG. 4). These metrics are the final outcomes on which the principles of program balancing for effectiveness are calculated.

Satisfaction (S_{N}) is a derived calculation based on the perceived satisfaction of each respondent (S) and the weighting (W_{FORMULA}) of questions in respective benefit categories (401). Satisfaction is expressed as a percentage on a scale of 0 to 100, and is visualized in various graphical formats. Satisfaction calculations are grouped and averaged on varying levels, including individual questions, benefits, policies, companies and industries; and may be parsed into additional groups representing counseling competence, service performance, benefit provisions and a variety of other applications.

Performance (P_{E}) is a derived calculation based on employee expectation (E) of each benefit category and aggregate satisfaction ratings (S_{N}) (402). Performance is expressed as a percentage on a scale of 0 to 200 and is graphically displayed on a two by two scatter plot grid. Performance calculations are grouped on varying levels, including individual questions, benefits, policies, companies and industries; and may be parsed into additional groups representing counseling competence, service performance, benefit provisions and a variety of other applications.

Productivity (P_{Y}) is a derived calculation based on normalized satisfaction (S_{NNorm}) ratings across user defined category groups (403). Calculated results are applied to proprietary productivity tables to determine actual productivity scores. Productivity results are used to compare two groups of like or diametrically opposing categories to measure and compare employee engagement. Productivity is expressed as a percentage on a scale of −50 to +50 and displayed on a bar chart with the x-axis at zero, which represents normal or average productivity.

Efficiency (E_{Y}) is a derived calculation based on perceived employee importance (I) of each benefit category and aggregate satisfaction ratings (S_{N}) (404). Efficiency is expressed as a percentage on a scale of 0 to 200 and graphically displayed in various formats. Efficiency calculations are grouped on varying levels, including individual questions, benefits, policies, companies and industries; and may be parsed into additional groups representing counseling competence, service performance, benefit provisions and a variety of other applications.

Program Application

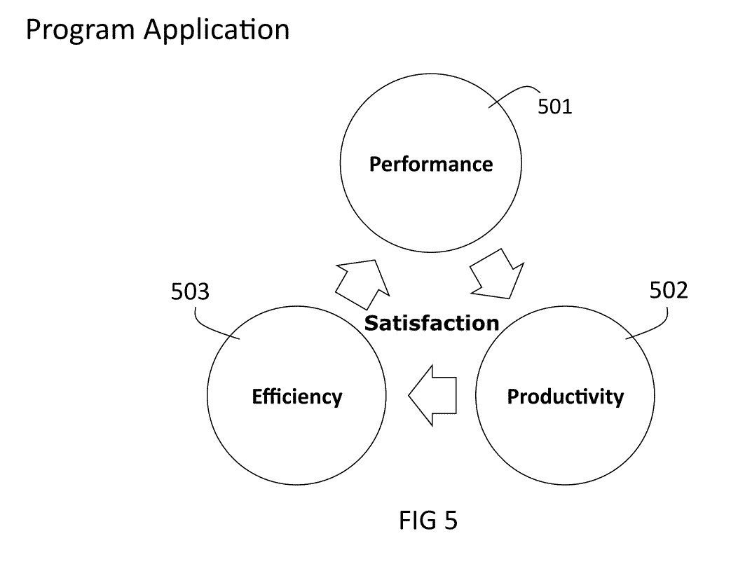

For the purpose of this invention, the performance, productivity and efficiency program commands a strategic balance of all three metrics in every instance (FIG. 5). It is the decision of the relocation program administrator to determine the program changes needed to achieve this balance.

The primary objective of the program is to migrate performance scores of each benefit towards 100 percent to ensure that satisfaction is meeting employee expectation (501). Through productivity modeling the performance scores can be adjusted upward or downward along the 100 percent performance curve to achieve higher or lower employee productivity or output (502). While balancing the needs of performance and productivity, efficiency is increased to match employee need to the importance of each benefit (503). These three steps (outlined below) should be administered in concurrent fashion to achieve harmonious results.

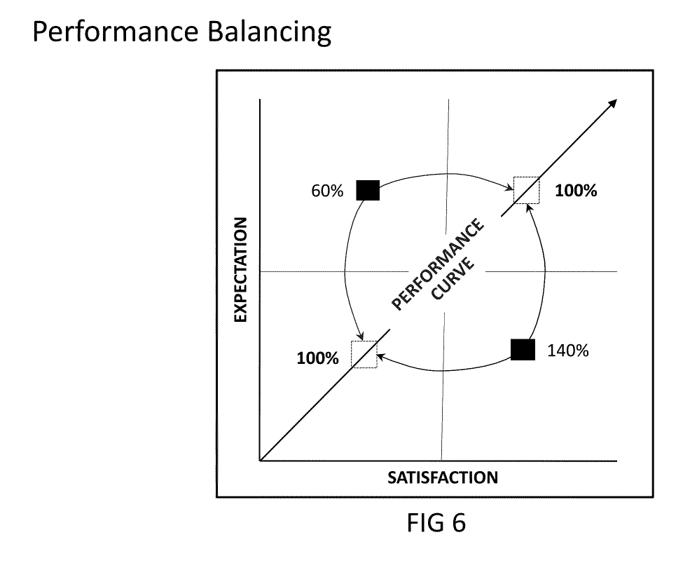

Step I: Performance is the primary objective for balancing relocation program effectiveness. The goal is to drive benefit performance to 100 percent, which places satisfaction equal to expectation. Graphically displayed on a two by two scatter plot grid, the performance curve is a straight line where x equals y; otherwise stated, where satisfaction equals expectation (FIG. 6). Scores above 100 percent are considered over performing and scores below 100 percent are under performing. Expectations should be raised or satisfaction should be lowered to drive over performing benefits to 100 percent. For under performing benefits, expectations should be lowered or satisfaction should be raised.

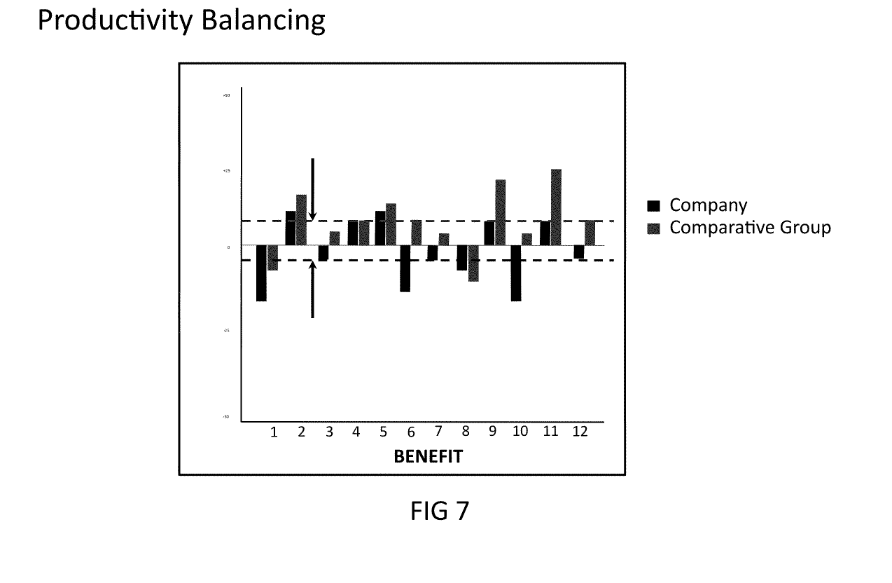

Step II: Productivity scores are a comparative analysis of two groups and are used to determine where performance scores should be positioned along the performance curve defined in Step I. As a measure of employee output, productivity determines if employees are more or less productive than a comparative group, such as an industry or peer group. Productivity scores range from the highest productivity of +47 percent to the lowest productivity of −47 percent, and are graphically displayed by benefit (FIG. 7). The base goal of productivity in relocation program effectiveness is to move each benefit towards zero, whereby average output or productivity is achieved. Notwithstanding, a higher-level goal of productivity for relocation program planning is to strategically position employee output against a comparative group. As a direct correlation to satisfaction, productivity is adjusted upward or downward by increasing or decreasing employee satisfaction in one or more benefit categories. By extension, adjusting productivity will impact performance scores, which are the primary indicators of relocation program effectiveness and must be managed concurrently. To achieve higher productivity along the performance curve, an increase in overall satisfaction and expectation should be implemented. To decrease productivity along the performance curve, a predominant decrease in overall satisfaction and expectation should be enacted.

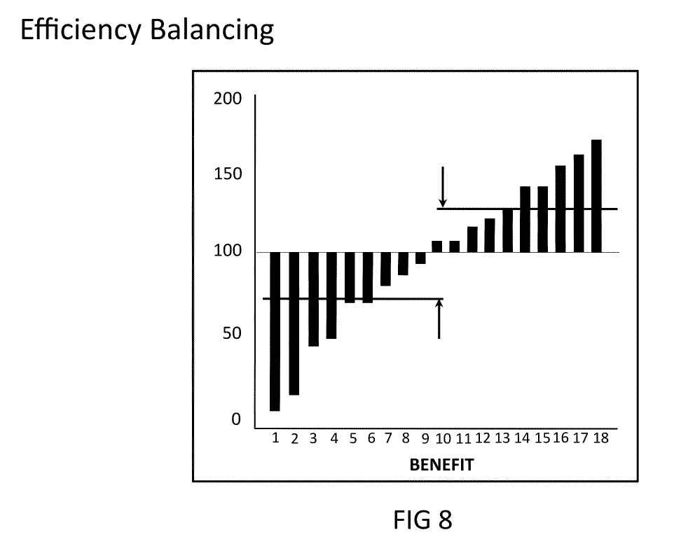

Step III: Efficiency is used to balance the level of services or benefit offerings against importance. When adjusting satisfaction for performance and productivity defined in Step I and Step II above, satisfaction results should also be adjusted concurrently to reflect the overall importance of each benefit. Benefits are considered inefficient when efficiency scores overly exceed or fall below 100 percent. Graphically displayed by benefit on a scale of 0 to 200 percent (FIG. 8), outlying benefit satisfaction scores should be adjusted in line with the perceived importance of each benefit. A reduction of services or benefits should be considered for benefits of low importance. For more important benefits, an increase of services or benefits should be considered. Although efficiency is an important part of the relocation program effectiveness balancing equation, less emphasis is placed on this part of the process when efficiency results conflict with overall performance and productivity planning.

Modeling and Planning

Striking a strategic balance of the program applications defined in the three steps above is in-kind to a three-dimensional puzzle. In order for the application to harmoniously come together, all three levers of the equation need to be worked concurrently. Multiple modeling scenarios in accordance with the outlined planning principles should be tested by a relocation program administrator who fully understands the performance, productivity and efficiency data; what the implications of change will be; and the overall impact to return on investment, program costs and talent mobility. In-depth planning should be conducted to achieve desired outcomes, along with scenario modeling and frequent follow-up compliance testing of future program performance.

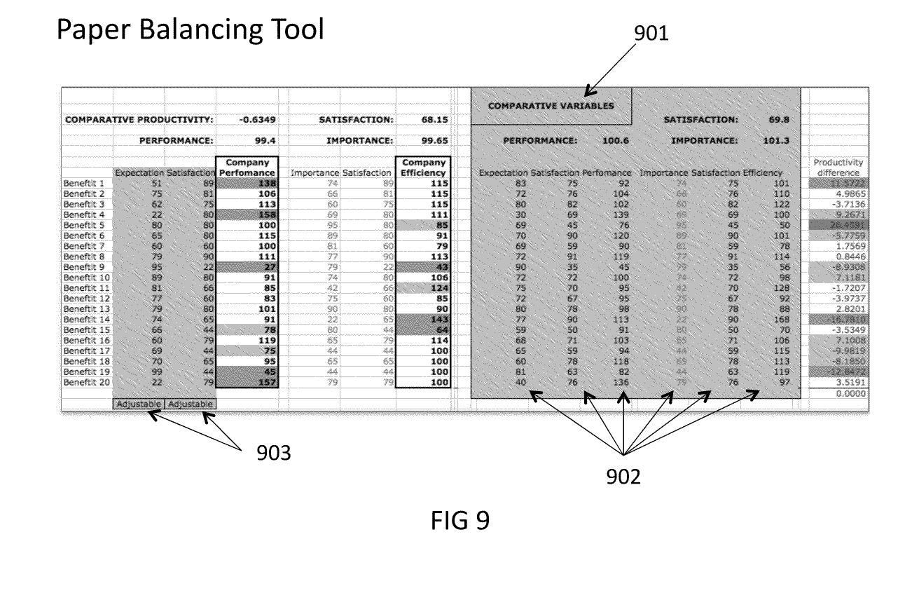

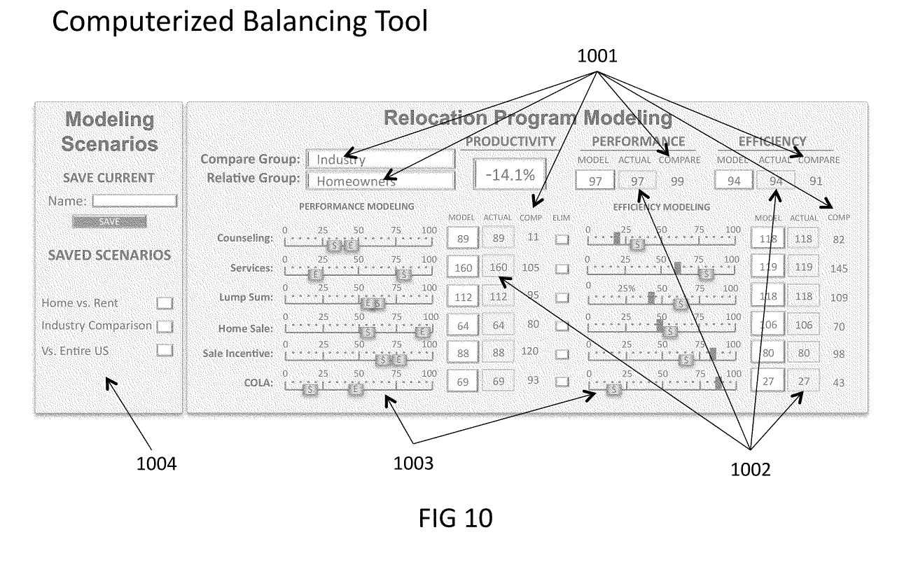

For the purpose of this invention, a performance, productivity and efficiency planning tool is defined both on paper (FIG. 9) and in computerized fashion (FIG. 10) to dynamically model the three-step balance process. The planning tools first calculate the performance, productivity and efficiency scores of all relocation benefits and applies them against a user-defined comparative group, such as industry or peer group, and/or an opposing category group such as homeowner versus renter (901) (1001). With present calculated scores held static in memory (902)(1002), the tool allows the user to dynamically adjust satisfaction and expectation scores up or down by benefit (903)(1003) to model one or more performance, productivity and efficiency scenarios. The user can choose to discard the model scenario if not desired, or save the model scenario for future validation of program development (1004). The planning tool also provides various ancillary options to add or eliminate benefits, visualize metrics per individual benefit, and various other functional options to facilitate program planning.

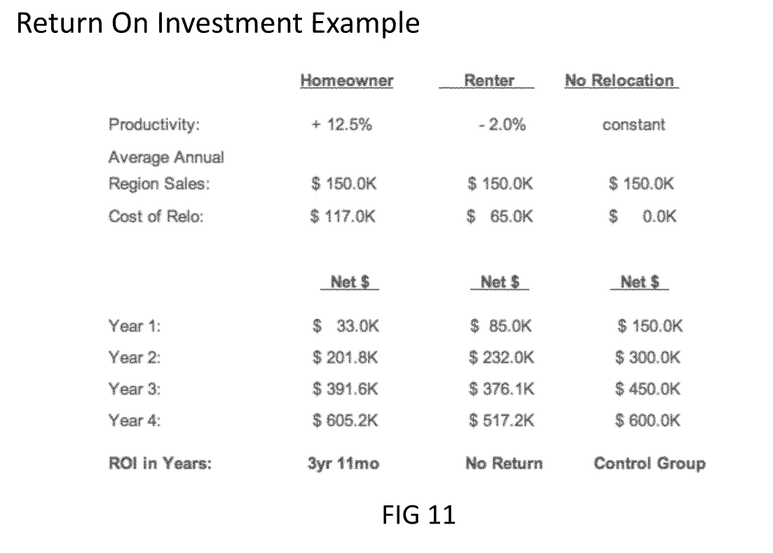

For the purpose of this invention and in addition to the performance, productivity and efficiency planning process, the proprietary productivity calculation is used as an external (outside of the relocation program) planning instrument for modeling relocated employee engagement in terms of ‘productivity’ for general corporate analyses who's formulae are not included in this invention, such as return on investment (FIG. 11), talent mobility planning and cost management. In these instances the relocation productivity score of any calculated comparison or diametrically opposing group is used to further assess relocation needs to better the employee selection process, better manage costs, or for use beyond those stated herein.

The preceding description has been presented only to illustrate and describe the embodiments of the principles and programs described. The description is not meant to be exhaustive or to limit these principles and programs to any precise form disclosed. Modifications and variations are possible and foreseeable to the above application.

What is claimed is:

1. A method of employee relocation program effectiveness planning comprising:
the collecting, categorizing and defining of employee satisfaction, expectation, importance and supporting results data;
for further calculation and application of performance, productivity and efficiency metrics;
for further application of principles and methodologies of employee relocation program and benefit balancing methods;
for further application of planning and modeling relocation program scenarios;
for further alternate application of productivity results;
for the purpose of producing more effective relocation program outcomes.

2. The method of claim 1, wherein:
employees of a company, corporation, government group or any other type of employer are surveyed to collect relocation program satisfaction data at the completion of a relocation from one geographical location to another;
a compilation of survey questions categorized by relocation benefit for the purpose of collecting satisfaction, expectation, importance and supporting data responses is administered directly to relocated employees;

3. The method of claim 1, further comprising:
the defining of ‘satisfaction’ to be the aggregate of counseling competence satisfaction, service performance satisfaction and benefit provision satisfaction;
the defining of ‘expectation’ to be what an employee expects to receive from the company in terms of services and benefit offerings;
the defining of ‘importance’ to be employee perception of importance for a given benefit, when compared to all other benefit offerings.
the defining of ‘supporting data’ to be other statistical information not defined by any other means herein.

4. The method of claim 1, further comprising:
the derivation of satisfaction scores through a calculation between satisfaction and weighting formulae; for further use in calculating performance, productivity and efficiency;
the derivation of performance scores through a calculation between satisfaction and expectation data; for further use in principles and methodologies of performance balancing;
the derivation of productivity scores through a calculation between satisfaction data and the application of proprietary productivity data tables; for further use in principles and methodologies of productivity balancing;
the derivation of efficiency scores through a calculation between satisfaction and importance data; for further use in principles and methodologies of efficiency balancing.

5. The method of claim 1, further comprising:
the defining of principles whereby benefit performance is optimal at a level of 100 percent; further defining that scores above said percentage are over performing and scores below said percentage are underperforming; further defining that optimal performance when viewed on a two by two scatter plot is at 100 percent when satisfaction equals expectation, otherwise stated where x equals y, and forms a straight line which is referred to as the ‘performance curve’;
the defining of principles whereby benefit productivity is a comparative measure of two complimentary or opposing groups or categories; for further defining that productivity is normal or average at a level of zero percent; further defining that negative values mean less employee productivity than the comparative group and positive values mean greater productivity than the comparative group;
the defining of principles whereby benefit efficiency is optimal at a level of 100 percent; further defining that scores above or below said percentage is inefficient.

6. The method of claim 1, further comprising:
the defining of methodologies to create a harmonious balance between performance, productivity and efficiency indicators; further defining that each indicator is balanced within it's own benefit category; further defining a concurrent balancing of all three indicators together; further defining performance to be the primary and most important indicator to achieve balance; further defining productivity to be the second most important indicator to achieve balance; further defining efficiency to be the third and least important indicator to achieve balance, noting that efficiency adjustments may undo prior performance and productivity balancing;
the defining of methodologies whereby benefit performance should seek to achieve optimal performance at 100 percent in every instance; further defining the increasing or decreasing of employee satisfaction, and/or the increasing or decreasing of employee expectations to achieve said percentage; whereby performance scores of said percentage can be achieved at any point along the performance curve depending on the level of productivity desired;
The defining of methodologies whereby a suitable comparative group is chosen to model productivity (e.g., company vs. the company's industry); further defining that benefit performance should seek to achieve an average or normal rate of zero percent in every instance in order to match comparative group performance; further defining the option to increase or decrease productivity versus comparative groups depending on desired outcomes; further defining the collective increasing of satisfaction and expectations to increase productivity, thus raising overall performance along the performance curve; further defining the collective decreasing of satisfaction and expectations to decrease productivity, thus lowering overall performance along the performance curve;
the defining of methodologies whereby benefit efficiency should seek to achieve optimal performance at 100 percent in instances where achieving said percentage does not negatively impact performance and productivity balancing methods; further defining the increasing or decreasing of employee satisfaction to achieve said percentage.

7. The method of claim 1, further comprising the modeling of scenarios for performance, productivity and efficiency planning to increase program effectiveness through the testing of multiple comparative or opposing productivity groups, and varying performance and efficiency scores.

8. The method of claim 1, wherein: the use of productivity scores comprises further use in the calculation processes of return on investment, talent mobility planning, cost management and other potential use claims within the realm of relocation program planning.

9. A system of relocation effectiveness planning comprising: a system of multiple computer mediums and databases with embodied programming code, data tables, graphical user interfaces and processes, designed to collect and process data to support the principles, methodologies and modeling of relocation program effectiveness planning.

10. The method of claim 9, further comprising:
the defining of worldwide web interface systems and databases for surveying relocated employees and collecting and storing satisfaction and supporting data responses for further application in master database systems;
the defining of master database systems for combining data from other systems and sources, for further calculation of all necessary outcomes.

11. The method of claim 9, further comprising:
the calculation of employee satisfaction responses to determine final satisfaction scores for counseling competence, service performance and benefit provisions both categorically and in totality;
the calculation of satisfaction, expectation and importance scores to determine performance, productivity and efficiency scores for general consumption and use in relocation program effectiveness planning;
the calculation of performance, productivity, and efficiency scores for application of relocation program effectiveness balancing principles, methods and modeling;
the calculation of productivity scores for exclusive use in business modeling of return on investment, talent mobility planning, cost management and other general corporate analyses relating to relocation planning.

12. The method of claim 9, further comprising:
the defining of paper or computerized worksheet applications programmed to dynamically balance and model relocation performance, productivity and efficiency scores in a visual manner for measuring internal company effectiveness and effectiveness against various external data points in a manner that supports the balancing principles of this invention.

13. The method of claim 9, further comprising:
the defining of a computer graphical interface with supporting programming and processes developed to dynamically balance and model relocation performance, productivity, efficiency and satisfaction scores in a visual manner for measuring internal company effectiveness and effectiveness against various external data points in a manner that supports the balancing principles of this invention.

14. The method of claim 13, further comprising the dynamic balancing and modeling of relocation program effectiveness by the user through a graphical user interface to:
dynamically choose or input comparative groups for further modeling calculations;
dynamically choose or input relative or comparative sub-groups for further modeling calculations;
visualize static performance, productivity, efficiency and satisfaction scores by benefit category and/or in totality for base effectiveness results or defined comparative and/or sub groups;
dynamically adjust satisfaction and expectation scores by benefit category using an embedded scale application with sliding buttons to model performance scores for overall relocation program modeling;
dynamically adjust satisfaction scores by benefit category using an adjacent embedded scale application with sliding buttons to model efficiency scores for overall relocation program modeling;
visualize the results of dynamically adjusted performance, productivity, efficiency and satisfaction scores by benefit category and/or in totality for the user group;
dynamically model additional supporting functions, such as the elimination or addition of benefit categories for the user group;
dynamically name and save a modeled scenario for future comparison, and/or recall previously saved modeled scenarios for comparison to current results.
